(19) United States
(12) Patent Application Publication
(10) Pub. No.: US 2020/0295849 A1
(43) Pub. Date: Sep. 17, 2020

(54) HIGH PERFORMANCE TELEMETRY SYSTEM WITH A COMBINATION OF SOFT AND HARD DECISION DECODNIG

(71) Applicant: Jiang Li, Katy, TX (US)

(72) Inventor: Jiang Li, Katy, TX (US)

(73) Assignee: Sine Cardinal LLC, Katy, TX (US)

(21) Appl. No.: 16/351,834

(22) Filed: Mar. 13, 2019

(51) Int. Cl. H04B 13/02; H04L 25/03; E21B 47/12

(52) U.S. Cl. CPC H04B 13/02; E21B 47/12; H04L 25/03312; H04L 25/03343

(57) ABSTRACT

The telemetry system used in the measurement while drilling (MWD) or logging while drilling (LWD) is essentially a digital communication system. The fact of the special and hostile drilling environment limits the use of many advanced techniques and equipment, and thus results in a low data transmission rate. While increasing the data rate for the MWD/LWD telemetry system becomes a primary focus, maintaining the system reliability and the decoding quality at a high data rate is equally challenging. This invention presents digital signal processing solutions to a high performance telemetry system with the high data rate, high system reliability, and high decoding quality.

[symbol]

### REFERENCE CITED

### US PATENT DOCUMENTS

U.S. Pat. No. 4,642,800 February 1987 Umeda

U.S. Pat. No. 4,908,804 March 1990 Rorden

U.S. Pat. No. 7,577,528 August 2009 Li et al.

### OTHER PUBLICAITONS

Jiang Li et al., “Efficient compression of borehole resistivity and acoustic imaging data using wavelets”, Geophysics, vol. 70, no. 6, November-December 2005, pp. F53-F60.
A. Oppenheim et al., “Discrete-time signal processing”, Prentice Hall, 1998.
J. Proakis, “Digital communications”, McGraw Hill, 2000.
G. Ungerboeck, “Trellis-coded modulation with redundant signal sets, Part II: State of the art”, IEEE Communication Magazine, vol. 25, no. 2, February 1987, pp. 12-21.
A. Viterbi, “Error bounds for convolutional codes and an asymptotically optimum decoding algorithm”, IEEE Transactions of Information Theory, vol. 13, no. 2, April 1967, pp. 260-269.

### BACKGROUND OF THE INVENTION

The telemetry system used in the measurement while drilling (MWD) or logging while drilling (LWD) is essentially a digital communication system. The commonly used communication media include the drilling mud, subsurface formation, the drill pipe, and the cable. Correspondingly, a communication system is called a mud pulse telemetry (MPT) system when a pulser is designed and used to regularly change the pressure or the flow rate of the drilling mud to generate pulse trains or continuous sinusoid waves, into which the digital information acquired at the downhole can be mapped, and thus conveyed to the surface. A communicate system is called an electromagnetic telemetry (EMT) system when an electromagnetic wave is generated at the downhole, travels through the subsurface formation, and received on the surface. A communicate system is called a wired pipe telemetry (WPT) system when wires are wrapped around the drill pipe and the digital information is conveyed through the wires, which may require more complicated design and equipment. Other forms of telemetry system, such as one using the acoustic waves traveling along the drill pipes to convey the digital information, exist but may not be as popular as the MPT and EMT systems in terms of a relatively good performance and cost ratio. On the other hand, however, the low data rate is a major concern for the MPT and EMT systems. It is always a challenge to find a balance point between increasing the data rate and maintaining the system reliability and the decoding quality. This invention presents digital signal processing (DSP) solutions to such a challenge.

In general, an MWD/LWD telemetry system works as shown in FIG. 1. The system consists of two parts, the downhole system and the surface system. The downhole system implements the data acquisition, encoding, modulation and transmission, and the surface system is to receive the transmitted signals, from which to recover the downhole data by the inverse steps, namely demodulation and decoding. Specifically, the data acquisition module in the downhole system may include a variety of sensors to obtain the downhole information, including but not limited to (1) the bottom hole assembly (BHA) orientation, i.e., tool face; (2) the wellbore survey, such as measured depth, inclination and azimuth; (3) the drilling related information, such as downhole temperature, mud pressure, rotations per minute (RPM), weight on bit, torque on bit, shocks and vibrations; and (4) the formation related information, such as natural gamma ray, resistivity, density and porosity. The data acquisition module may also include an analog to digital (A/D) converter, to generate the digital information by sampling and digitizing the analog measurements from the sensors. Once the digital information is available, a series of DSP operations, such as data compression, data frame, channel coding and modulation, will play important roles to get the downhole information ready to be transmitted to the surface efficiently. The data compression is to remove the redundant information inherent in the measurements, and thus reduce the total amount of information that needs to be transmitted, essentially increasing the data rate in an indirect way. The data frame is an operation to pack the digital information into multiple frames with the additions of the frame identifications and the synchronization information for the purpose of convenience and robustness of the digital communications. The channel coding is to introduce some redundant information with known patterns, as opposed to the data compression, for the purpose of detecting and correcting errors during the digital communications. The modulation is to map the digital information into some high frequency carrier signals for the purpose of improving overall performance of the telemetry system. Once the modulated digital signals are ready, a digital to analog (D/A) converter in the transmitter module may be used to convert the digital information to analog signals that will then be used to drive a transmitter, such as a pulser, to send the downhole information to the surface.

The receiver module in the surface system may use certain types of receivers, such as sensors to detect changes of pressure or flow rate of the drilling mud, to receive the downhole information sent by the downhole system. Then, an analog to digital (A/D) converter may be used to generate the digital information by sampling and digitizing the received analog signals. Once the digital information is available, a series of DSP operations, such as demodulation, channel decoding, data de-frame and data de-compression, may be conducted to recover the original downhole information. These DSP operations are basically the inverse operations of those conducted in the downhole systems. Because of the inversible property of these DSP operations, the original downhole information can be recovered easily if the received signals are the same as the transmitted signals, which requires an ideal communication channel where neither noise nor distortion occurs. Unfortunately, however, the reality is that the hostile drilling environment introduces all types of noise and distortion during the communications, which makes the recovery of the original downhole information from the received signals become extremely challenging. This invention presents DSP solutions to such a challenge.

### SUMMARY OF THE INVENTION

One embodiment of the invention is the DSP solutions to a high performance telemetry system of transmitting the downhole measurements and information to the surface with the high data rate, high system reliability and high decoding quality. The system consists of a downhole system and a surface system. The DSP solutions to the downhole system include the compact representation of the digitized downhole measurements and information; the packing of the digital information into data frames, with additions of information such as frame identification and synchronization; the introduction of redundant information with known patterns to the data frame; the modulation of the digital information onto high frequency carrier signals, with choices of various carrier frequencies and modulation techniques. The DSP solutions to the surface system include the demodulation of the digital information from the received carrier signals; the detection and correction of errors in the received digital information by making use of the transmitted redundant information with known patterns; the unpacking of the digital information from the data frame by making use of the information of synchronization and frame identification; the recovery of the original information from the compact representation of the downhole measurements and information.

Another embodiment of the invention is the DSP solutions to combat the noise and distortion in the received signals, introduced by the hostile drilling environment, in order to recover the downhole information with high decoding quality and to make the system work with high reliability. The DSP solutions include the noise suppression of the received carrier signals; the compensation of the signal distortion caused by non-ideal communication channel; the synchronization and timing between the transmitter and the receiver; the coherent and non-coherent demodulation; and the optimum estimation and decision making to recover the original downhole information with high confidence.

### BRIEF DESCRIPTION OF THE DRAWINGS

FIG. 1 shows a block diagram of a MWD/LWD telemetry system.

FIG. 2 shows a process of the modulation and demodulation with an ideal communication channel.

FIG. 3 shows a process of the modulation and demodulation with a non-ideal communication channel.

FIG. 4 shows a process of the channel equalization with the soft decision decoding.

FIG. 5 shows a process of the channel equalization with the hard decision decoding.

FIG. 6 shows a process of the channel equalization with a combination of the soft and hard decision decoding.

### DETAILED DESCRIPTION OF THE INVENTION

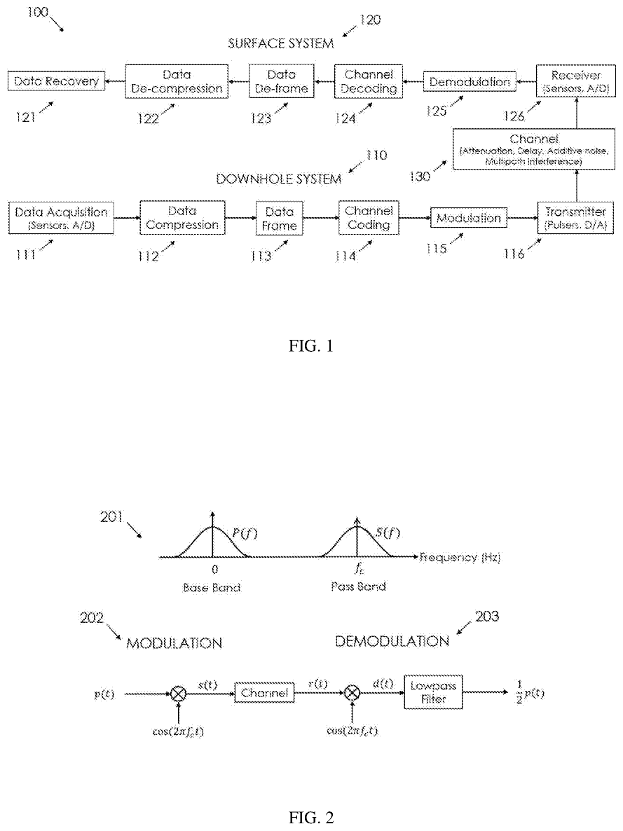

The MWD/LWD telemetry system, as shown in FIG. 1, is essentially a digital communication system. The system 100 consists of two parts, the downhole system 110 and the surface system 120. The communication channel 130 connects the two parts, where the noise and distortions such as attenuation, delay, and multipath interference may be introduced to the signals transmitted from the downhole system 110 so that the signals received at the surface system 120 will be different from the transmitted signals. How to recover the transmitted signals and further the original downhole information from the received signals reliably and accurately, particularly at high data rate, becomes a primary challenge. The DSP methods provide solutions to such a challenge. In general, the DSP methods for the downhole system 110 includes the data compression 112, the data frame 113, the channel coding 114, and the modulation 115. The DSP methods for the surface system 120 includes the data de-compression 122, the data de-frame 123, the channel decoding 124, and the demodulation 125.

The data compression 112 in the downhole system 110 is to implement the compact representation of the downhole measurements from the data acquisition 111. In general, the data compression is implemented in consecutive three steps. The first step is to remove the redundant information, which is essentially the correlations among measurements. For the same reason, this step is also referred to as the de-correlation. The methods for the de-correlation fall into two categories, the differential and the transformation. The differential method is to represent the original measurements in two parts, a predefined reference and the differences from the reference. If the correlations in the measurements are high, then the differences will be low, which means the original information can be represented in a compact way. The transformation follows the similar concept, which is to represent the original information in a different domain, where the information is compacted into a small group of transformation coefficients. The commonly used transformations include the cosine transform, a variant of the Fourier transform, and the wavelet transform (Li et al., 2005). The second step is called the quantization, which is a process to remove insignificant information while preserving the significant information. The consequences from the quantization lie in two folds. On one hand, it saves the bandwidth of the communication since only a fraction of information is transmitted. In many cases, it is acceptable because the information that is not transmitted is insignificant. On the other hand, there is a loss of information, although insignificant, for which case the data compression is called the lossy compression. In order to preserve all the information, the quantization will not be applied, for which case the data compression is called the lossless compression. The third step is called coding, which is essentially an efficient way to represent the de-correlated information. Two commonly used skills for the coding are the entropy coding and the bit-plane coding. The entropy coding, such as the Huffman coding and the arithmetic coding, makes use of the probability distribution information of symbol alphabets to encode different symbols with different-length codewords. Basically, short codewords are used for the symbols with high occurring frequency and long codewords for the symbols with low occurring frequency. As a result, on average with the probability as a weight, for the same amount of information smaller number of binary bits is needed to represent the same information. Since the length of the codewords are different for the different symbol, the entropy coding is often referred to as the variable-length coding. The bit-plane coding essentially incorporates the quantization into the coding, and basically preserves or transmits the most significant bit in a codeword first and the least significant bit last. The data compression represents the original information in a compact way and essentially increases the data rate in an indirect way. The data compression is an inversible operation, and thus the data de-compression 122 in the surface system 120 is simply an inverse step to recover the original information from the compact representations.

The data frame 113 in the downhole system 110 is to pack the original digital information from the data acquisition 111, or the compact digital information from the data compression 112, into multiple frames. The contents of the information to be packed and the way how the information to be packed is defined in the frame identifications. In addition, in order to make the surface system and the downhole system work on the same data frame, certain synchronization information is added to the data frame. The data de-frame 123 in the surface system 120 is simply to extract the contents in the data frame by using the synchronization and frame identification information.

The channel coding 114 in the downhole system 110 is to implement the error protection of the data frame 113. The idea is to introduce certain redundant information with known patterns to the data frame. If there is any errors occurred during the communication, the channel decoding 124 in the surface system 120 is able to use the known patterns to detect and even to correct the errors during the decoding process. In general, there are two types of channel coding, the linear block coding and the convolutional coding. The commonly used parity check belongs to the linear block coding. Other examples of the linear block coding include but not limit to the Hamming code, the cyclic redundancy code, and the reed solomon code. The convolutional coding becomes popular because of an optimum and efficient decoding algorithm, namely the Viterbi algorithm (Viterbi, 1967).

The modulation 115 in the downhole system 110 is to map the digital information in the data frame 113 protected by the channel coding 114 into some high frequency carrier signals, which will be sent through the communication channel to the surface in an efficient way. The demodulation 125 in the surface system 120 is basically to recover the digital information from the received carrier signals. The demodulation 125 becomes complicated and challenging when the received carrier signals are contaminated by the channel noise and distortions. It is worth to mention that when the channel coding 114 and the modulation 115 are implemented jointly, the overall performance of the communication system may be improved. This process is known as the trellis coded modulation (Ungerboeck, 1982).

FIG. 2 shows how the modulation and demodulation works when the communication channel is an ideal channel with neither noise nor distortions. Mathematically, the process of modulation 202 is basically a product of a signal pulse p(t) bearing the digital information and a sinusoid signal with a given carrier frequency f_{c}, i.e.,

s(t)=p(t)·cos(2πf_{c}t)

where s(t) is called the modulated signal, which is also the signal that will be transmitted through the communication channel. It is known that the product operation in time domain is equivalent to the convolutional operation in the frequency domain. Therefore, the process of modulation 202 may be expressed in the frequency domain mathematically as,

S(f)=P(f)*½[δ(f−f_{c})+δ(f+f_{c})]

where the notation * represents a convolution operation, S(f) and P(f) are the spectrum of s(t) and p(t), respectively, and δ(f) is a delta function. Note that this convolution operation is basically a translation process 201, wherein the spectrum, P(f), of a signal pulse p(t), located at the zero frequency or in the base band, is translated to the high-frequency pass band, located at the carrier frequency f_{c} and its symmetry −f_{c}. If ignoring the negative frequency, with a proper normalization, the spectrum, S(f), of the modulated signal s(t) is simply a translated and duplicated version of the spectrum, P(f), of the original signal, p(t), i.e.,

S(f)=P(f−f_{c})

The advantages of using the modulation may include but not limited to avoiding large-size antenna, allowing bandwidth sharing, avoiding low-frequency noise, and achieving high data rate.

In the process of modulation 202, there are basically three parameters that can be modulated, and they are the amplitude A, carrier frequency f_{c}, and phase ϕ of the sinusoid carrier signal, in its typical form, A·cos(2πf_{c}t+ϕ). When the amplitude is modulated, its corresponding digital modulation process is called an amplitude shift keying (ASK). When the carrier frequency is modulated, its corresponding digital modulation process is called a frequency shift keying (FSK). When the phase is modulated, its corresponding digital modulation process is called a phase shift keying (PSK). There are also many variants from these three basic modulation processes.

Mathematically, the process of demodulation 203 is basically a product of the received signal r(t) and a sinusoid signal with the same carrier frequency f_{c}, followed by a lowpass filter. When the communication channel is ideal, the received signal r(t) is the same as the modulated and transmitted signal s(t), i.e., r(t)=s(t). Therefore, the demodulated signal before the lowpass filter is,

d(t)=r(t)·cos(2πf_{c}t)=p(t)·cos²(2πf_{c}t)=p(t)·½[1+cos(4πf_{c}t)]

The lowpass filter removes the frequency that is two times of the carrier frequency, and consequently the original signal pulse p(t) may be recovered from the signal d(t).

When the communication channel is not ideal, as shown in FIG. 3, the received signal v(t) is a contaminated version of the modulated signal s(t). If the communication channel is represented by its channel impulse response h(t) and the additive noise to the communication channel is represented by n(t), then the received signal v(t) can be represented as,

v(t)=s(t)*h(t)+n(t)

In order to recover the original signal pulse p(t), the modulated signal s(t) needs to be recovered from the contaminated receiving signal v(t). Obviously, the additive noise n(t) needs to be removed, which is known as a process of noise suppression 304. Ideally, after the noise suppression, the contaminated receiving signal v(t) becomes,

w(t)=v(t)−n(t)=s(t)*h(t)

Then, the channel impulse response h(t) needs to be matched so that the modulated signal s(t) can be extracted from w(t). This process is known as the channel equalization 305, which is expressed mathematically as,

r(t)=s(t)*h(t)*c(t)

where c(t) is defined as the impulse response of a matched filter. It is known that the convolutional operation in time domain is equivalent to the product operation in the frequency domain, and thus the process of channel equalization 305 is expressed mathematically in the frequency domain as,

R(f)=S(f)·H(f)·C(f)

Note that if H(f)·C(f)=1, then R(f)=S(f) , or equivalently r(t)=s(t) . That is, the modulated signal s(t) and thus the original signal pulse p(t) is recovered from the contaminated receiving signal v(t) after the noise suppression and the channel equalization. The condition H(f)·C(f)=1 for the channel equalization yields that the frequency response of the matched filter c(t) is the inverse of the frequency response of the communication channel h(t), i.e.,

C(f)=H⁻¹(f)

In addition, when the communication channel is not ideal, the carrier frequency and phase used in the demodulation 303 may deviate from the carrier frequency and phase used in the modulation 302, and thus the process of demodulation 303 becomes,

d(t)=r(t)·cos[2π(f_{c}+Δf)t+θ]=p(t)·cos(2πf_{c}t)·cos[2π(f_{c}+Δf)t+θ]

In this case, the original signal pulse p(t) may not be recovered from d(t) by simply using a lowpass filter, as for the case of the ideal communication channel. Therefore, it is preferred that there is a process that can synchronize the carrier frequency and phase at the modulation and demodulation.

In short, the demodulation process becomes complicated and challenging when the communication channel is not ideal, as encountered in the MWD/LWD telemetry system. Three processes, namely the noise suppression, the channel equalization, and the synchronization, are in need to recover the original signals from the contaminated receiving signals. The performance of these three processes will eventually determine the overall performance of the telemetry system.

The noise in the telemetry system is generally treated as the additive noise, which may fall into three categories: wideband, narrowband and harmonic noise. The wide-band noise may be suppressed by classical lowpass, highpass and bandpass filters, with either linear-phase finite impulse response (FIR) implemented by the windowing methods, or infinite impulse response (IIR) implemented by the butterworth, Chebyshev or elliptic approximation methods (Oppenheim et al., 1998). The narrowband may be suppressed by bandstop or notch filters. The pump noise in the MPT telemetry system may be treated as a type of narrow-band harmonic noise. The methods to suppress such noise include but not limited to the method of making use of the pump stroke information, such as U.S. Pat. No. 4,642,800 and the method of using adaptive notch filtering, such as U.S. Pat. No. 7,577,528.

The synchronization for the telemetry system includes the carrier synchronization, which is usually implemented by the adaptive methods such as phase locked loop (PLL), and the symbol synchronization and the frame synchronization, which are usually implemented by the correlation or matched filtering of specially designed synchronization symbols (Proakis, 2000).

The channel equalization is to combat two types of channel distortions, namely the frequency selective distortion and the intersymbol inference (ISI). The frequency selective distortion may be compensated by finding the frequency response of a channel equalizer matched to the frequency response of the telemetry channel, as shown in FIG. 3. The frequency response of the telemetry channel may be obtained by sending a set of training signals, such as chirps, through the telemetry system, and the calculating the ratio of the frequency responses of the input to and output from the system.

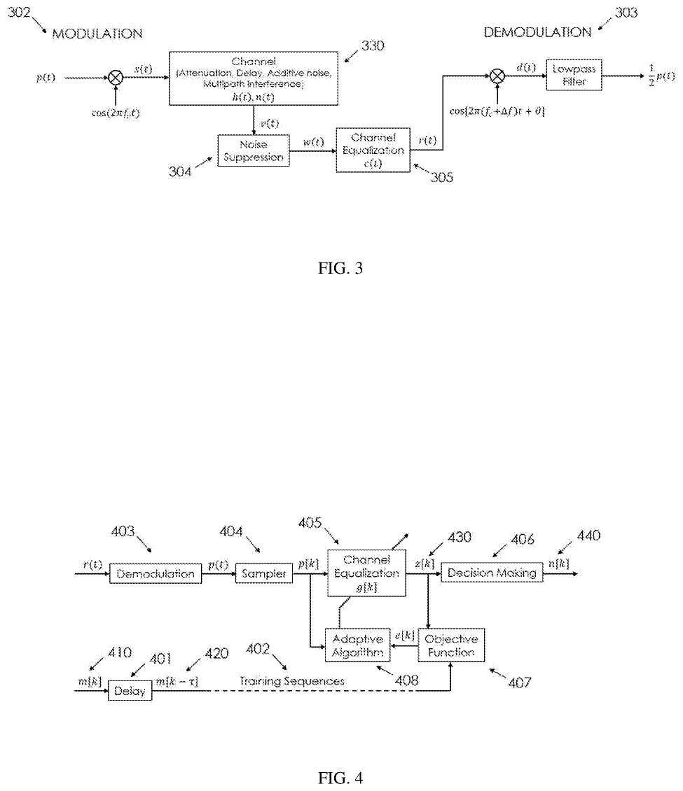

FIG. 4 shows the adaptive channel equalization method to compensate for the ISI. The adaptive method is essentially an optimization problem, which is generally implemented in three steps: defining an objective function, optimizing the objective function, and testing the objective function. In the case of the channel equalization, the objective function 407 is defined as a function of the error between the output from the channel equalizer 405 and a desired signal 402. The adaptive algorithm 408 is used to optimize the objective function. The channel equalizer 405 is essentially a FIR filter, represented by a finite number of coefficients g [k], and thus the channel equalization is essentially a filtering process, defined as a convolution of the input to the channel equalizer the FIR filter g [k]. Therefore, the adaptive algorithm 408 is to iteratively update the FIR filter coefficients g [k], based upon the input to the channel equalizer and the desired signal 402, in order to optimize the objective function 407.

One of the commonly used adaptive algorithm is the least mean square (LMS) algorithm, in which the objective function is defined as the mean squared error (MSE) between the output from the channel equalizer 405 and a desired signal 402. The minimization of the objective function is implemented through a stochastic steepest-descent algorithm, where a gradient function is calculated by using the second-order statistics or moments of the input information, namely the covariance of the input to the channel equalizer 405 and the cross-correlation between the input and the desired signal 402. The steepest-descent algorithm uses a single adaptive parameter, which makes the algorithm simple but also results in a slow convergence of the optimization process. Furthermore, the LMS algorithm uses an estimate of the gradient function for the simplicity.

Another commonly used adaptive algorithm is the recursive least squares (RLS) or Kalman algorithm, in which the objective function is defined as the weighed sum of the squared error between the output from the channel equalizer 405 and a desired signal 402. Different from the LMS algorithm where an expected value of the squared error, i.e. MSE, or an ensemble average is minimized, the RLS algorithm is essentially to minimize a time average, i.e., the weighed sum of the squared error. As a result, the RLS algorithm uses multiple adaptive parameters, which leads to a complex algorithm but a fast convergence of the optimization process.

The channel equalization shown in FIG. 4 assumes that the desired signal 402 is known, which is simply a delayed version 420 of the original signal 410. This known desired signal 402 is typically referred to as a training sequence. The error sequence that is used to form the objective function 407 and further used in the adaptive algorithm 408 is simply the difference between the delayed version 420 of the original signal 410 and the demodulated value after the channel equalization 430, i.e.,

e [k]=m[k−τ]−z [k]

where the demodulated value after the channel equalization 430, z[k], is defined as the soft decision, and thus the decision making 406 is called the soft decision making. The advantage of the using the training sequences for the channel equalization is obvious, but it comes with the cost of the communication bandwidth.

When the training sequences are not available, the channel equalization is typically referred to as the self-recovering or blind equalization, as shown in FIG. 5. The decision making 506 is to find an optimal approximation of the demodulated value after the channel equalization 530. When the decision making 506 is defined as a quantization operation, the optimal approximation may be defined as the nearest element in the message alphabet, i.e.,

n[k]=Q {z[k]}

As compared to the soft decision, this type of decision making is called the hard decision making and the optimal approximation, n[k], is called the hard decision. The decision making 506 may also be a sign operation. The error sequence using the hard decision for the channel equalization without the training sequences is defined as the difference between the hard decision 540 and the soft decision 530, i.e.,

e[k]=n[k]−z[k]=Q{z[k]}−z[k]

This type of channel equalization is also referred to as the decision directed or decision feedback equalization.

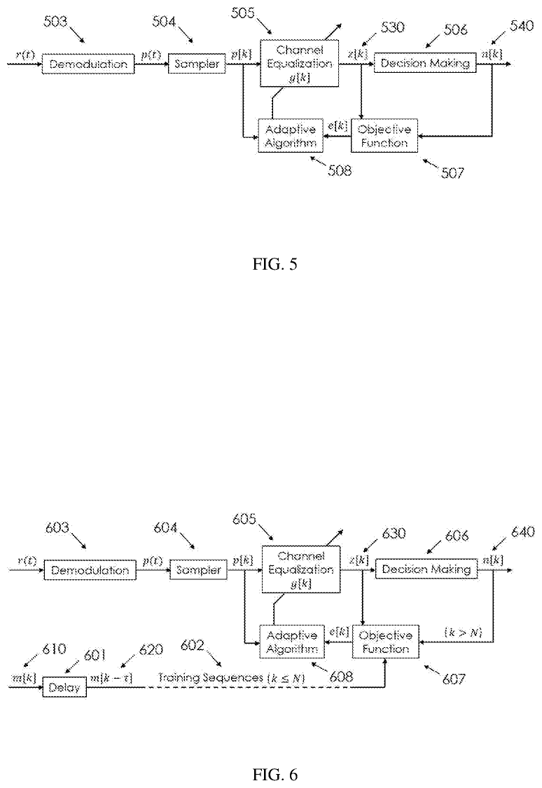

FIG. 6 shows the use of a combination of the soft decision and the hard decision for the channel equalization, where a set of training sequences, e.g., the synchronization sequence itself, is first used for the channel equalization with soft decision and then the blind channel equalization for the message sequences is implemented by using the hard decision.

The method of using the pulse shaping may also be used to overcome the ISI. In the previous discussion of the channel equalization, it is desired to have a channel equalization filter to match the channel filter, i.e., C (f)=H⁻¹(f), in order to recover the original signal pulse p (t), from which the message bearing in the binary bit stream may be recovered. In fact, as long as the signal pulse p(t) is sampled at the correct time so that the sampled value p[k]=p(kT) has no ISI, the message represented the signal pulse p(t) will be recovered. That is, it is not really the entire shape of the signal pulse p (t) but rather its value at the sampling instant that matters for the message recovery. In general, if the sampled value p [k] is zero at all integer multiples of sampling interval T but one, then this sampled value will not interfere with other sampled values at the sample instants kT, and the signal pulse can have any shape in between without causing any ISI. This condition is known as the Nyquist criterion, i.e.,

$$p ( k T - τ ) = p [ k - τ ] = \{ \begin{matrix}c & k = 0 \\ 0 & k \neq 0\end{matrix}$$

where c is a nonzero constant, k is an integer and τ is a time delay. Note that the commonly used pulse shapes such as rectangle, sinc, and raised cosine satisfy the Nyquist criterion.

In the context of the communication system, it is said that it is not really the signal pulse itself, but rather the combination of the signal pulse and the receiver, that satisfies the Nyquist criterion. In other words, it is desired to have a receiver filter, g [k], that matches the signal pulse so as to simultaneously overcome the ISI and maximize the signal-to-noise ratio at the receiver. Interestingly note that this receiver filter g [k] is the adaptive channel equalization filter 405, 505, and 605, with soft and hard decision decoding, as shown in FIGS. 4, 5, and 6, respectively. The combination of the signal pulse and the receiver filter is a convolution in time domain, or a product in frequency domain. The convolution of rectangle signal pulse with itself is a triangle signal, which satisfies the Nyquist criterion with the good timing, i.e., sampling at the middle peak of the triangle. The convolution of sinc signal pulse with itself is a sinc signal, and thus satisfies the Nyquist criterion. However, the convolution of the raised cosine signal pulse with itself does not satisfy the Nyquist criterion. Since the raised cosine signal pulse has some good properties, such as the bandwidth efficiency and the rapid die-away of the impulse response, it is good to have a signal pulse that preserves these properties and satisfies the Nyquist criterion as well. The square root raised cosine (SRRC) is such a signal pulse, which may be found by taking the inverse Fourier transform of the square root of the frequency response of the raised cosine signal pulse.

What is claimed is:

1. A high performance telemetry system, comprising a downhole system and a surface system, that transmits downhole drilling related information and subsurface formation measurements to the surface with high data rate, high system reliability and high decoding quality.

2. The system of claim 1 wherein a series of digital signal processing methods for the downhole system and the surface system are used to realize the digital communications between the downhole and the surface with high data rate, high system reliability and high decoding quality.

3. The method of claim 2 wherein the downhole measurements or information is represented in the form of binary bits through the Nyquist sampling and digitization in the downhole system; and later is recovered from the binary bits received and processed in the surface system.

4. The method of claim 2 wherein the binary bit representations of the downhole measurements or information is further represented in a compact form in the downhole system to reduce the total amount of information that needs to be transmitted to the surface and thus to achieve the high data rate in an indirect way; and later the compact binary bit representations of the downhole measurements or information are uncompacted in the surface system.

5. The method of claim 2 wherein the binary bit representations, or the compact binary bit representations, of the downhole measurements or information, are packed into multiple data frames, with additions of binary bits that represent the frame identifications and the synchronization information, in the downhole system; and later the binary bit representations, or the compact binary bit representations, of the downhole measurements or information, are recovered from the data frame by using the frame identifications and the synchronization information in the surface system.

6. The method of claim 2 wherein certain redundant information with known patterns in the form of binary bits is added to the data frames in the downhole system for the purpose of combating the bit errors occurred during the digital communications; and later the bit errors in the received and processed binary bits are detected and corrected by using the redundant information with known patterns in the surface system.

7. The method of claim 2 wherein the binary bits in the data frames in the downhole system are represented by a series of signal pulses that satisfy the Nyquist criterion to overcome the intersymbol interference.

8. The method of claim 2 wherein the binary bits in the data frames, or the Nyquist signal pulse representations of the binary bits in the data frames, are mapped into high frequency carrier signals by modulating the amplitude, frequency, phase, or the combination of any two or three elements, of the carriers in the downhole system.

9. The method of claim 2 wherein the noise in the received carrier signals, such as the wideband, narrowband, and harmonic noise, is suppressed by a series of digital filters, such as lowpass, highpass, bandpass, bandstop, and notch filters in the surface system.

10. The method of claim 2 wherein the distortion in the received carrier signals, such as the frequency selective distortion and the intersymbol interference, is compensated by the channel equalization digital filters in the surface system.

11. The method of claim 2 wherein the binary bits in the data frames are recovered by the coherent or noncoherent demodulation of the received carrier signals and the decision making in the surface system.

12. The method of claim 2 wherein the system response of the telemetry system is obtained by using a series of training signals, and the inverse of the system response is used to compensate for the frequency selective distortion in the surface system.

13. The method of claim 2 wherein an optimal channel equalization filter is found by solving an optimization problem iteratively, and then used to compensate for the intersymbol inference in the surface system.

14. The method of claim 13 wherein an optimization problem is solved iteratively by using the adaptive algorithms, such as least mean squares and recursive least squares algorithms, to optimize an objective function in the surface system.

15. The method of claim 14 wherein an objective function of the optimization problem is defined as a function of the error between the soft decision of the demodulated signal and a set of training sequences used for the desired signal.

16. The method of claim 14 wherein an objective function of the optimization problem is defined as a function of the error between the soft decision of the demodulated signal and the hard decision of the demodulated signal when the training sequences are not available.

17. The method of claim 14 wherein an objective function of the optimization problem is defined as a combination of the objective functions defined for the soft decision and the hard decision.
